(19) United States
(12) Patent Application Publication
(10) Pub. No.: US 2015/0228218 A1
(43) Pub. Date: Aug. 13, 2015

(54) DRIVER INTEGRATED CIRCUIT AND DISPLAY DEVICE HAVING THE SAME

(71) Applicant: Samsung Display Co., Ltd., Yongin-City (KR)

(72) Inventor: Jung-Hoon Shim, Seoul (KR)

(21) Appl. No.: 14/520,155

(22) Filed: Oct. 21, 2014

(30) Foreign Application Priority Data
Feb. 12, 2014 (KR) 10-2014-0015888

(51) Int. Cl. G09G 3/20

(52) U.S. Cl. CPC G09G 3/2096; G09G 2300/0426; G09G 2300/0434; G09G 2300/0408

(57) ABSTRACT

A driver integrated circuit and a display device using the same are disclosed. In one aspect, the driver integrated circuit comprises a base substrate having two opposing short sides and two opposing long sides. The driver integrated circuit further comprises an input pad formed adjacent to one of the long sides, a first output pad formed adjacent to a first one of the short sides, a second output pad formed adjacent to a second one of the short sides, a first internal line formed over the base substrate and electrically connecting the first output pad to the second output pad, and a second internal line formed over the base substrate and electrically connecting the input pad to the first internal line.

### INCORPORATION BY REFERENCE TO ANY PRIORITY APPLICATIONS

This application claims priority under 35 U.S.C. §119 to Korean patent Application No. 10-2014-0015888, filed on Feb. 12, 2014, the disclosure of which is hereby incorporated by reference herein in its entirety.

### BACKGROUND

1. Field

The described technology generally relates to a driver integrated circuit and a display device having the same.

2. Description of the Related Technology

A display device can be used in various electronic devices such as a monitor, a television, a digital information display device (DID), a laptop, a digital camera, a cellular phone, a smart phone, a smart pad, a tablet, a personal digital assistant (PDA), a portable multimedia player (PMP), an MP3 player, a navigation system, a video camcorder, a game console, etc. Generally, the display device can include a display panel, a driver integrated circuit, a pad part, a flexible printed circuit board, etc.

Recently, more pads and/or lines are being formed in the pad part of the display device because there is a demand for high resolution. Therefore, the area of the pad part has been increasing.

### SUMMARY OF CERTAIN INVENTIVE ASPECTS

One inventive aspect is a driver integrated circuit including internal lines interconnecting an input pad with first and second output pads to reduce an area of a pad part.

Another aspect is a display device having the driver integrated circuit chip.

Another aspect is a driver integrated circuit chip including a base substrate, an input pad, an second output pad, a first internal line, and a second internal line. The input pad can be arranged near a long side of the base substrate. The first output pad can be arranged near a first short side of the base substrate. The second output pad can be arranged near a second short side opposed to the first short side of the base substrate. The first internal line can be arranged on the base substrate and can interconnect the first output pad with the second output pad. The second internal line can be arranged on the base substrate and can include a first end portion electrically connected to the input pad and a second end portion electrically connected to the first internal line.

In some embodiments, a direct current (DC) voltage generated from the driver integrated circuit chip can be output to a display region of a display panel through the first output pad and the second output pad.

In some embodiments, the input pad can be connected to a capacitor for stabilizing the DC voltage output through the first output pad and the second output pad.

In some embodiments, the capacitor can be formed on a flexible printed circuit board.

In some embodiments, the capacitor can be formed in the driver integrated circuit chip.

In some embodiments, the capacitor can be connected to the first internal line or the second internal line.

In some embodiments, the capacitor can be formed on the display panel on which the driver integrated circuit chip is mounted.

In some embodiments, the input pad can be electrically connected to an input line extending to a pad part of the display panel connected to a flexible printed circuit board. In this case, the capacitor can be connected to the input line.

In some embodiments, the first output pad can be electrically connected to a first output line extending to a display region of a display panel, and the second output pad can be electrically connected to a second input line extending to the display region of the display panel. In this case, the capacitor can be connected to at least one of the first output line and the second output line.

In some embodiments, the first output pad can be electrically connected to a first output line extending a display region of a display panel, and the second output pad can be electrically connected to a second input line extending the display region of the display panel. In this case, the first output line and the second output line can be interconnected with each other by the first internal line.

In some embodiments, the input pad can be electrically connected to an input line extending to a pad part of the display panel connected to a flexible printed circuit board. In this case, each of the first output line and the second output line can be connected to the input line by the first internal line and the second internal line.

In some embodiments, the first output pad and second output pad can receive a signal applied from a flexible printed circuit board to the input pad to output the signal applied from the flexible printed circuit board to a display region of a display panel using the first internal line and second internal line.

Another aspect is a display device including a display panel, a driver integrated circuit chip, a first pad part, and a second pad part. The display panel can include a display region and a peripheral region adjacent to the display region. The driver integrated circuit chip can be formed in the peripheral region of the display panel. The first pad part can be formed in the peripheral region of the display panel to make contact with the driver integrated circuit chip. The second pad part can be formed in the peripheral region of the display panel to make contact with a flexible printed circuit board. The driver integrated circuit chip can include a base substrate, at least one input pad arranged near a long side of the base substrate, at least one first output pad arranged near a first short side of the base substrate, at least one second output pad arranged near a second short side opposed to the first short side of the base substrate, a first internal line formed on the base substrate, the first internal line interconnecting the first output pad with the second output pad, and a second internal line formed on the base substrate, the second internal line including a first end portion electrically connected to the input pad and a second end portion electrically connected to the first internal line.

In some embodiments, the input pad can be connected to a capacitor for stabilizing the direct current voltage output through the first output pad and the second output pad.

In some embodiments, the capacitor can be formed on the flexible printed circuit board.

In some embodiments, the flexible printed circuit board can include a base film, at least one input pad pattern formed on the base film, and at least one input line pattern formed on the base film, the input line pattern electrically connected to the input pad pattern. In this case, the capacitor can be electrically connected to the input line pattern.

In some embodiments, the capacitor can be electrically connected to at least one of the first internal line of the driver integrated circuit chip and the second internal line of the driver integrated circuit chip.

In some embodiments, the first pad part can include at least first pad, at least one second pad, at least one third pad. The at least first pad can make contact with the input pad of the driver integrated circuit chip and can be electrically connected to the input line extending the first pad part and the second pad part. The at least second pad can make contact with the first input pad of the driver integrated circuit chip and can be electrically connected to a first output line extending to the display region of the display panel. The at least one third pad can make contact with the second input pad of the driver integrated circuit chip and can be electrically connected to a second output line extending to the display region of the display panel. In this case, the capacitor can be connected to at least one of the input line, the first input line, and the second input line.

In some embodiments, a first output line extending to the display region of the display panel and a second output line extending to the display region of the display panel can be interconnected with each other by the first internal line of the driver integrated circuit. Here, each of the first output line and the second output line can be connected to an input line extending from the first pad part to the second pad part by the first internal line of the driver integrated circuit and the second internal line of the driver integrated circuit.

In some embodiments, the second pad part can include at least one fourth pad electrically connected to the input line, and the first output pad and second output pad receive a signal applied from a flexible printed circuit board to the fourth pad to output the signal applied from the flexible printed circuit board to the display region of the display panel using the first internal line and second internal line.

Another aspect is a driver integrated circuit for a display device, the driver integrated circuit comprising a base substrate having two opposing short sides and two opposing long sides, an input pad formed adjacent to one of the long sides, a first output pad formed adjacent to a first one of the short sides, a second output pad formed adjacent to a second one of the short sides, a first internal line formed over the base substrate and electrically connecting the first output pad to the second output pad, and a second internal line formed over the base substrate and electrically connecting the input pad to the first internal line.

In the above driver integrated circuit, the input pad is configured to receive a direct current (DC) voltage and output the DC voltage to a display region of a display panel through the first and second output pads. In the above driver integrated circuit, the input pad is electrically connected to a capacitor configured to stabilize the DC voltage. In the above driver integrated circuit, the capacitor is formed over a flexible printed circuit board (FPCB).

In the above driver integrated circuit, the capacitor is formed over the base substrate. In the above driver integrated circuit, the capacitor is electrically connected to the first or second internal line.

In the above driver integrated circuit, the capacitor is formed in the display panel. In the above driver integrated circuit, the input pad is electrically connected to an input line extending to a pad part of the display panel and electrically connected to a flexible printed circuit board, and the capacitor is electrically connected to the input line.

In the above driver integrated circuit, the first output pad is electrically connected to a first output line extending to a display region of the display panel, and the second output pad is electrically connected to a second output line extending to the display region, and the capacitor is electrically connected to at least one of the first and second output lines.

In the above driver integrated circuit, the first output pad is electrically connected to a first output line extending to a display region of a display panel, wherein the second output pad is electrically connected to a second input line extending the display region, and wherein the first and second output lines are electrically connected to each other through the first internal line. In the above driver integrated circuit, the input pad is electrically connected to an input line extending to a pad part of the display panel and electrically connected to a flexible printed circuit board, and each of the first and second output lines are electrically connected to the input line respectively through the first and second internal lines.

In the above driver integrated circuit, the first and second output pads are configured to i) receive a signal from the flexible printed circuit board via the input pad, and ii) provide the received signal to a display region of a display panel.

Another aspect is a display device, comprising a display panel including a display region and a peripheral region adjacent to the display region, and a driver integrated circuit formed in the peripheral region. The driver integrated circuit comprises a base substrate having two opposing short sides and two opposing long sides, an input pad formed adjacent to one of the long sides, a first output pad formed adjacent to a first one of the short sides, a second output pad formed adjacent to a second one of the short sides, a first internal line formed over the base substrate and electrically connecting the first output pad to the second output pad, and a second internal line formed over the base substrate and electrically connecting the input pad to the first internal line.

In the above display device, the input pad is electrically connected to a capacitor configured to stabilize the direct current (DC) voltage output through the first and second output pads. In the above display device, the capacitor is formed over the flexible printed circuit board. In the above display device, the flexible printed circuit board includes a base film, an input pad pattern formed over the base film, and an input line pattern formed over the base film and electrically connected to the input pad pattern, wherein the capacitor is electrically connected to the input line pattern.

In the above display device, the capacitor is electrically connected to at least one of the first and second internal lines.

In the above display device, the driver integrated circuit includes a first pad electrically connected to the input pad through an input line, a second pad electrically connected to the first input pad and a first output line extending to the display region, and a third pad electrically connected to the second input pad and a second output line extending to the display region, wherein the capacitor is electrically connected to at least one of the input, first output and second output lines.

The above display device further comprises first and second output lines extending to the display region and electrically connected to each other through the first internal line, wherein each of the first and second output lines is electrically connected to an input line through the first and second internal lines. The above display device further comprises at least one fourth pad electrically connected to the input line, wherein the first and second output pads are configured to receive a signal received from the flexible printed circuit board, and wherein the first and second output pads are configured to output the signal to the display region through the first and second internal lines.

In another aspect, a driver integrated circuit chip in accordance with some embodiments can include at least one input pad, at least one first output pad, at least one second output pad, a first internal line, and a second internal line. Here, the input pad can be connected to a capacitor for stabilizing a direct current voltage output through the first output pad and the second output pad, and then the first and second output pads can output a direct current voltage stabilized by the capacitor to a display region of a display panel using the first and second internal line. Furthermore, the first and second output pads can output signals applied from a flexible printed circuit board to the input pad to the display region of the display panel using the first and second internal lines. As a result, an area of a pad part can be reduced.

In another aspect, a display device can include the driver integrated circuit chip. Thus, lines and pads can be efficiently arranged in a peripheral region of the display panel. In order words, the lines adjacent to each other and the pads adjacent to each other can be spaced apart from each other by a constant distance. Therefore, a contact defect between the lines adjacent to each other and a contact defect between the pads adjacent to each other can be reduced. As a result, the display device can be stably driven (i.e., the display device can ensure a relatively improved driving stability.)

### BRIEF DESCRIPTION OF THE DRAWINGS

FIG. 1 is a perspective view illustrating a driver integrated circuit chip in accordance with some embodiments.

FIG. 2 is a perspective view illustrating a driver integrated circuit chip in accordance with some embodiments.

FIG. 3 is a perspective view illustrating a driver integrated circuit chip in accordance with other some embodiments.

FIG. 4 is a perspective view illustrating a display device in accordance with some embodiments.

FIG. 5 is a perspective view illustrating a first pad part and a second pad part of a display device of FIG. 4.

FIG. 6 is a perspective view illustrating a display device of FIG. 4 in which a flexible printed circuit board is contacted.

FIG. 7 is a plan view illustrating a flexible printed circuit board of FIG. 6.

### DETAILED DESCRIPTION OF CERTAIN INVENTIVE EMBODIMENTS

Hereinafter, a driver integrated circuit chip and a display device having the driver integrated circuit chip in accordance with example embodiments will be explained in detail with reference to the accompanying drawings. In this disclosure, the term “substantially” includes the meanings of completely, almost completely or to any significant degree under some applications and in accordance with those skilled in the art. Moreover, “formed on” can also mean “formed over.”

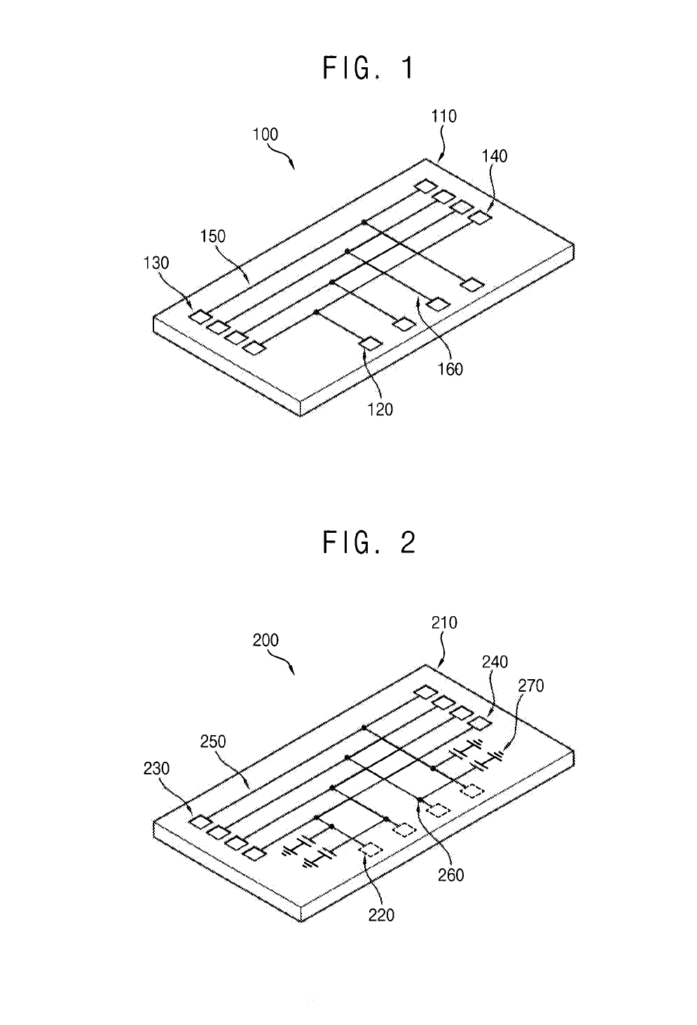

FIG. 1 is a perspective view illustrating a driver integrated circuit chip in accordance with some embodiments.

Referring to FIG. 1, a driver integrated circuit chip 100 includes a base substrate 110, an input pad 120, a first output pad 130, a second output pad 140, a first internal line 150, a second internal line 160, etc.

The base substrate 110 can include a driving circuit (i.e., the driving circuit can be formed in the base substrate 110). For example, the base substrate 110 can convert a driving voltage, a clock signal or an image signal provided from a flexible printed circuit board with driving signals (e.g., timing signal, scan signal, data signal, etc.) to an output signal. The base substrate 110 can be formed of a flexible material. For example, the base substrate 110 can be formed of polyimide (PI), polyethylene terephthalate (PET), and polyethylene naphthalate (PEN). Alternatively, the base substrate 110 can be formed of a material having a relatively high strength.

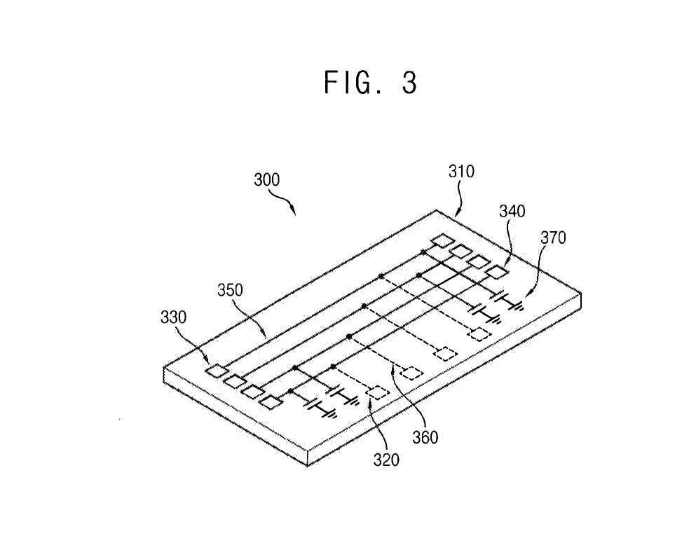

The input pad 120 can be formed near a long side of the driver integrated circuit chip 100. In some embodiments, the input pad 120 can receive a direct current (DC) voltage generated from the driver integrated circuit chip 100. For example, the direct current voltage can correspond to a high gate voltage (V_{GH}), a low gate voltage (V_{GL}), an initialize voltage (Vᵢₙₜ), a bias voltage (V_{bias}), etc. The direct current voltage can be output to the first and second output pads 130 and 140 through the first and second internal lines 150 and 160. In some embodiments, the direct current voltage can be stabilized by a capacitor connected to the input pad 120, and then the stabilized direct current voltage can be output to a display panel through the first and second output pads 130 and 140. In some embodiments, the capacitor can be formed on the flexible printed circuit board. In some embodiments, the capacitor can be formed in the driver integrated circuit chip 100 (i.e., the capacitor can be formed in the driver integrated circuit chip 100.) In some embodiments, the capacitor can be formed on the display panel on which the driver integrated circuit chip 100 is mounted. The capacitor will be described with reference to FIGS. 2 and 3.

Alternatively, the input pad 120 can receive signals from the flexible printed circuit board. In some embodiments, the signals can be output to the first and second output pads 130 and 140 through the first and second internal lines 150 and 160. Thus, the signals can be applied from the flexible printed circuit board, and then the signals can be provided to the display panel through the input pad 120, the first output pad 130, and the second output pad 140.

In some embodiments, the input pad 120 can be formed of a metal such as copper (Cu), tungsten (W), silver (Ag), aluminum (Al), etc. In some embodiments, the input pad 120 can include a copper foil. For example, the input pad 120 can have a rectangular shape with the substantially same size when viewed from the top. However, the described technology is not limited thereto. For example, the input pad 120 can have various shapes, such as a square shape, a hexagonal shape, a circular shape, an elliptical shape, and a polygonal shape when viewed from the top.

As illustrated in FIG. 1, the input pad 120 can be arranged near the long side in one row. However, arrangements of the input pad 120 are not limited thereto. For example, the input pad 120 can be formed in a first row through (N)th row, where N is an integer greater than or equal to 2.

The second output pad 140 can be formed near a second short side of the driver integrated circuit chip 100 on an opposite side of a first short side of the driver integrated circuit chip 100. The second output pad 140 can be electrically connected to a second output line that extends to the display region to provide the direct current voltage and/or the signals to the display region.

The second output pad 140 can be formed of a metal such as copper, tungsten, silver, aluminum, etc. Alternatively, the second output pad 140 can have a rectangular shape with the substantially same size when viewed from the top. However, the described technology is not limited thereto. For example, the second output pad 140 can have various shapes, such as a square shape, a hexagonal shape, a circular shape, an elliptical shape, and a polygonal shape when viewed from the top.

As illustrated in FIG. 1, the first output pad 130 can be arranged near the first short side in one row. However, arrangements of the first output pad 130 are not limited thereto. For example, the first output pad 130 can be formed in a first row through (N)th row, where N is an integer greater than or equal to 2.

As illustrated in FIG. 1, the second output pad 140 can be arranged near the second short side in one row. However, arrangements of the second output pad 140 are not limited thereto. For example, the second output pad 140 can be formed in a first row through (N)th row, where N is an integer greater than or equal to 2.

The first internal line 150 can be arranged on (i.e., printed or formed on) the base substrate 110 so as to electrically connect the first and second output pads 130 and 140. The first internal line 150 can be formed of a metal such as copper, tungsten, silver, aluminum, etc. Alternatively, the first internal line 150 can include a copper foil.

The second internal line 160 can be arranged on (i.e., printed or formed on) the base substrate 110. In some embodiments, a first end portion of the second internal line 160 can be electrically connected to the input pad 120 and a second end portion of the second internal line 160 can be electrically connected to the first internal line 150. Accordingly, each of the first and second output lines can be electrically connected to the input line. In other words, the first and second output pads 130 and 140 can be electrically connected to the input pad 120 through the first and second internal lines 150 and 160.

As a result of the described technology, the area of a pad part (or pad region) can be reduced.

FIG. 2 is a perspective view illustrating a driver integrated circuit chip in accordance with some embodiments. A driver integrated circuit chip 200 described with reference to FIG. 2 can have a configuration substantially the same as or substantially similar to that of the driver integrated circuit chip 100 described with reference to FIG. 1 except a capacitor 270. Therefore, duplicated descriptions are omitted.

Referring to FIG. 2, the driver integrated circuit chip 200 can include a base substrate 210, an input pad 220, a first output pad 230, a second output pad 240, a first internal line 250, a second internal line 260, a capacitor 270, etc.

The base substrate 210 can include a driving circuit. (i.e., the driving circuit can be formed in the base substrate 210.) For example, the base substrate 210 can convert a driving voltage, a clock signal or an image signal provided from a flexible printed circuit board with driving signals (e.g., timing signal, scan signal, data signal, etc.) to output signals.

The input pad 220 can be formed near a long side of the driver integrated circuit chip 200. In some embodiments, the input pad 220 can receive a direct current voltage generated from the driver integrated circuit chip 200. For example, the direct current voltage can correspond to a high gate voltage (V_{GH}), a low gate voltage (V_{GL}), an initialize voltage (Vᵢₙₜ), a bias voltage (V_{bias}), etc. The direct current voltage can be output to the first and second output pads 230 and 240 through the first and second internal lines 250 and 260. In some embodiments, the direct current voltage can be stabilized by a capacitor connected to the input pad 220, and then the stabilized direct current voltage can be output to a display panel through the first and second output pads 230 and 240. For example, the capacitor 270 can be connected to the second internal line 260. In some embodiments, the direct current voltage can be stabilized by the capacitor 270 electrically connected to the second internal line 260 instead of a typical flexible printed circuit board on which a capacitor is mounted, so that a number of the input pads 220 can be reduced or removed. Accordingly, the input pad 220 is indicated using dotted lines. However, a function of the input pad 220 is not limited thereto. The input pad 220 can receive driving signals from the flexible printed circuit board. In some embodiments, the input pad 220 can be formed of a metal such as copper (Cu), tungsten (W), silver (Ag), aluminum (Al), etc. In some embodiments, the input pad 220 can include a copper foil.

The first output pad 230 can be formed near a first short side of the driver integrated circuit chip 200. The first output pad 230 can be electrically connected to a first output line that extends to the display region so as to provide the direct current voltage and/or the signals to the display region. For example, the first output pad 230 can be formed of copper, tungsten, silver, aluminum, etc. Alternatively, the first output pad 230 can include a copper foil.

The second output pad 240 can be formed near a second short side of the driver integrated circuit chip 200 on an opposite side of the first short side. The second output pad 240 can be electrically connected to a second output line so as to provide the direct current voltage and/or the signals to the display region. For example, the second output pad 240 can be formed of copper, tungsten, silver, aluminum, etc. Alternatively, the second output pad 240 can include a copper foil.

The input pad 220, the first output pad 230, and the second output pad 240 can have a rectangular shape with the substantially same size when viewed from the top. However, the described technology is not limited thereto. For example, the input pad 220, the first output pad 230, and the second output pad 240 can have various shapes, such as a square shape, a hexagonal shape, a circular shape, an elliptical shape, and a polygonal shape when viewed from the top.

The first internal line 250 can be arranged on (i.e., printed or formed on) the base substrate 210 so as to electrically connect the first output pad 230 to the second output pad 240. For example, the first internal line 250 can be formed of copper, tungsten, silver, aluminum, etc. Alternatively, the first internal line 250 can include a copper foil.

The second internal line 260 can be arranged on (i.e., printed or formed on) the base substrate 210. In some embodiments, a first end portion of the second internal line 260 can be electrically connected to the input pad 210 and a second end portion of the second internal line 260 can be electrically connected to the first internal line 250. Each of the first and second output lines can be electrically connected to the input line. The first and second output pads 230 and 240 can be electrically connected to the input pad 220 through the first and second internal line 250 and 260 electrically connected to each other.

The capacitor 270 can be electrically connected to the second internal line 260. As illustrated in FIG. 2, the capacitors 270 can be respectively electrically connected to the second internal lines 260. The capacitor 270 can stabilize signals (e.g., direct current voltage) generated from the driver integrated circuit chip 200. Thus, the area of the flexible printed circuit board can be efficiently utilized compared to a typical capacitor mounted on a typical flexible printed circuit board because the capacitor in accordance with some embodiments is not mounted on the flexible printed circuit board. For example, a camera, a sensor, etc. can be additionally formed in the typical flexible printed circuit board where the typical capacitor was mounted.

FIG. 3 is a perspective view illustrating a driver integrated circuit chip 300 in accordance with some embodiments. The driver integrated circuit chip 300 can have a configuration substantially the same as or substantially similar to that of the driver integrated circuit chip 100 described with reference to FIG. 1 except a capacitor 370. Therefore, duplicated descriptions are omitted.

Referring to FIG. 3, the driver integrated circuit chip 300 includes a base substrate 310, an input pad 320, a first output pad 330, a second output pad 340, a first internal line 350, a second internal line 360, a capacitor 370, etc.

The base substrate 310 can include a driving circuit (i.e., the driving circuit can be formed in the base substrate 310). For example, the base substrate 310 can convert a driving voltage, a clock signal or an image signal provided from a flexible printed circuit board with driving signals (e.g., timing signal, scan signal, data signal, etc.) to an output signal.

The input pad 320 can be arranged near a long side of the driver integrated circuit chip 300. In some embodiments, the input pad 320 can receive a direct current voltage generated from the driver integrated circuit chip 300. For example, the direct current voltage can correspond to a high gate voltage (V_{GH}), a low gate voltage (V_{GL}), an initialize voltage (Vᵢₙₜ), a bias voltage (V_{bias}), etc. The direct current voltage can be output to the first and second output pad 330 and 340 through the first and second internal line 350 and 360. In some embodiments, the direct current voltage can be stabilized by the capacitor 370 electrically connected to the input pad 320, and then the direct current voltage can be output through the first and second output pad 330 and 340. In some embodiments, the capacitor 370 can be connected to the second internal line 360. In some embodiments, the direct current voltage can be stabilized by the capacitor 370 connected to the second internal line 360 instead of a capacitor mounted on a typical flexible printed circuit board, so that a number of the input pads 320 can be reduced or removed. Accordingly, the input pad 320 and the second internal line 360 are indicated using dotted lines. However, a function of the input pad 320 is not limited thereto. The input pad 320 can receive driving signals from the flexible printed circuit board in accordance with some embodiments.

The input pad 320 can be formed of a metal such as copper, tungsten, silver, aluminum, etc. Alternatively, the input pad 320 can include a copper foil.

The first output pad 330 can be arranged near a first short side of the driver integrated circuit chip 300. The first output pad 330 can be electrically connected to the first output line that extends to the display region so as to provide the direct current voltage and/or the signals to the display region. For example, the first output pad 330 can be formed of a metal such as copper, tungsten, silver, aluminum, etc. Alternatively, the first output pad 330 can include a copper foil.

The second output pad 340 can be arranged near a second short side of the driver integrated circuit chip 300 on an opposite side of the first short side. The second output pad 340 can be electrically connected to a second output line so as to provide the direct current voltage and/or the signals to the display region. For example, the second output pad 340 can be formed of copper, tungsten, silver, aluminum, etc. Alternatively, the second output pad 340 can include a copper foil.

The input pad 320, the first output pad 330, and the second output pad 340 can have a rectangular shape with the substantially same size when viewed from the top. However, the described technology is not limited thereto. For example, the input pad 320, the first output pad 330, and the second output pad 340 can have various shapes, such as a square shape, a hexagonal shape, a circular shape, an elliptical shape, and a polygonal shape when viewed from the top.

The first internal line 350 can be arranged on (i.e., printed or formed on) the base substrate 310 so as to electrically connect the first output pad 330 to the second output pad 340. The first internal line 350 can be formed of a metal such as copper, tungsten, silver, aluminum, etc. Alternatively, the first internal line 350 can include a copper foil.

The second internal line 360 can be arranged on (i.e., printed or formed on) the base substrate 310. In some embodiments, a first end portion of the second internal line 360 can be electrically connected to the input pad 310 and a second end portion of the second internal line 360 can be electrically connected to the second internal line 360. Thus, each of the first and second output lines can be electrically connected to the input line. In other words, the first and second output pads 330 and 340 can be electrically connected to the input pad 320 through the first and second internal line 350 and 360 electrically connected to each other.

The capacitor 370 can be electrically connected to the first internal line 350. In some embodiments, the capacitor 370 can be respectively connected to the first internal lines 350. The capacitor 370 can stabilize signals (e.g., direct current voltage) generated from the driver integrated circuit chip 300. Thus, the area of the flexible printed circuit board can be efficiently utilized compared to that of a typical flexible printed circuit board because the capacitor in accordance with some embodiments is not mounted on the flexible printed circuit board. For example, a camera, a sensor, etc can be additionally formed where the typical capacitor was mounted.

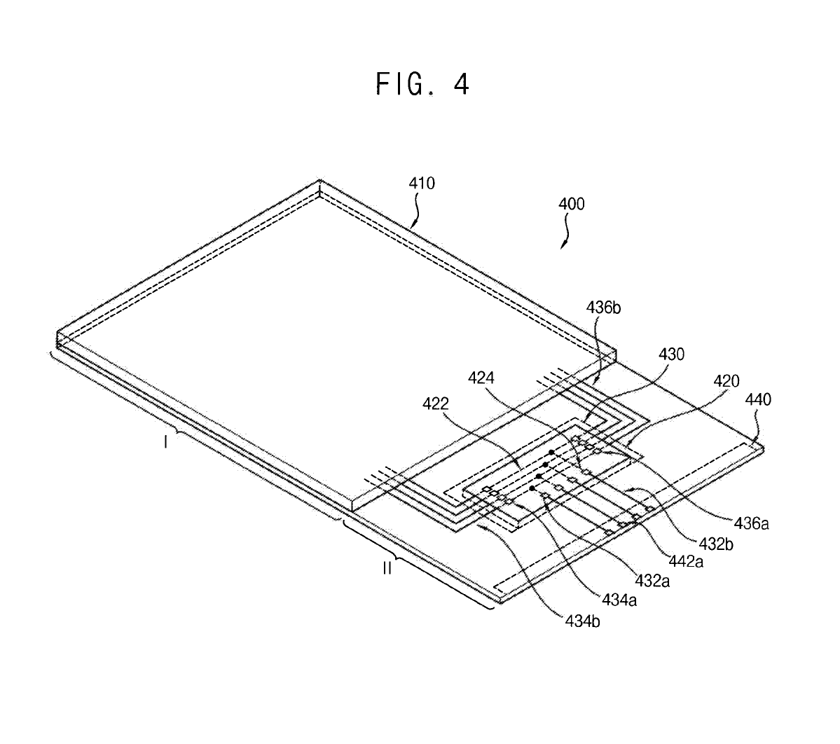

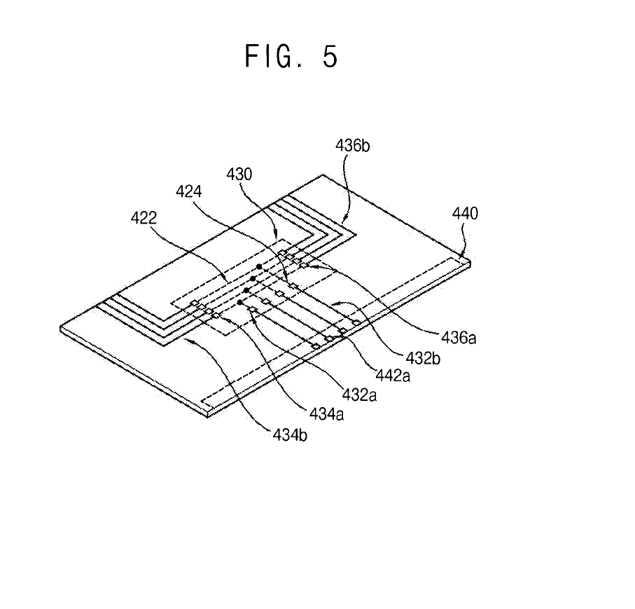

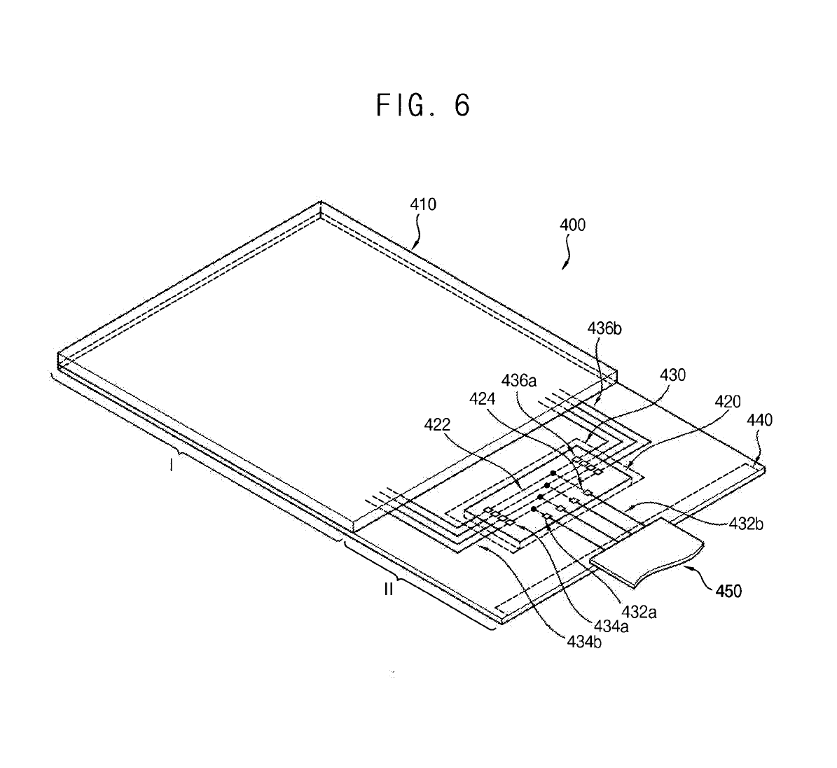

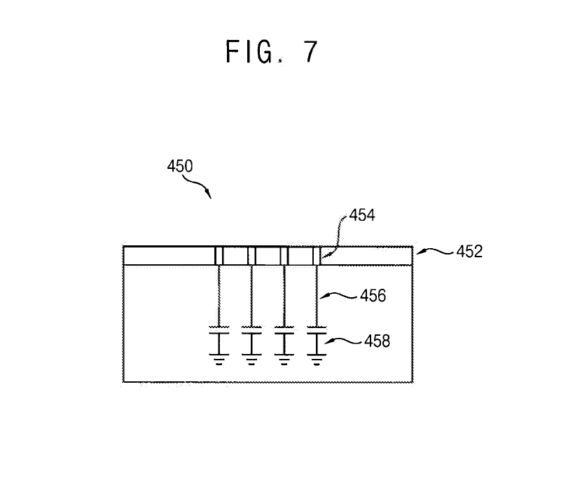

FIG. 4 is a perspective view illustrating a display device in accordance with some embodiments. FIG. 5 is a perspective view illustrating a first pad part and a second pad part of the display device of FIG. 4. FIG. 6 is a perspective view illustrating the display device of FIG. 4 in which a flexible printed circuit board is contacted. FIG. 7 is a plan view illustrating the flexible printed circuit board of FIG. 6.

Referring to FIGS. 4 through 7, a display device 400 includes a display panel 410, a driving chip 420, a first pad part 430, a second pad part 440, a flexible printed circuit board 450, etc.

The display panel 410 can include a display region I and a peripheral region II adjacent to the display region I . In some embodiments, a plurality of pixels are formed in the display region I , and the driving chip 420, a first pad 432a, an input line 432b, a first output line 434b, a third pad 436a, a second output line 436b, a fourth pad 442a, etc. can be formed in the peripheral region 11.

The driver integrated circuit chip 420 can be formed in the peripheral region II. For example, the driver integrated circuit chip 420 can be formed to be electrically connected to the first pad part 430 using a chip-on-glass process. An adhesive member can be interposed between the driving chip 420 and the first pad part 430, and then the driving chip 420 and the first pad part 430 can be thermally pressured together. Accordingly, the driving chip 420 can be combined with the first pad part 430. For example, the adhesive member can include an anisotropic conductive film. The anisotropic conductive film can be formed of conductive particles such as nickel, carbon, solder ball, etc. and an adhesive polymer.

The first pad part 430 can be formed in the peripheral region II . The first pad part 430 can include the first to third pads 432a, 434a and 436a. As illustrated in FIG. 5, the first pad 432a can contact the input pad of the driver integrated circuit chip (see FIG. 1) and can be electrically connected to the input line 432b that extends to the first pad part 430 and the second pad part 440. The second pad 434a can contact the first output pad of the driver integrated circuit chip (see FIG. 1) and can be electrically connected to the first output line 434b that extends to the display region I . The third pad 436a can contact the second output pad of the driver integrated circuit chip (see FIG. 1) and can be electrically connected to the second output line 436b. In this case, the second pad 434a can be electrically connected to the third pad 436a by a first internal line 422 of the driver integrated circuit chip. In addition, the first pad 432a can be electrically connected to the second and third pads 434a and 436a through the first and second internal lines 422 and 424. Alternatively, the capacitor can be electrically connected to the first and second output lines 434b and 436b. Here, the first and second output line 434b and 436b can be electrically connected to each other through the first internal line 422. The first and second output lines 434b and 436b can be electrically connected to the input line 432b through the first and second internal lines 422 and 424.

The second pad part 440 can be formed in the peripheral region II . The second pad part 440 can contact the flexible printed circuit board 450. In some embodiments, the second pad part 440 can include the fourth pad 442a.

The flexible printed circuit board 450 can include a base film 452, an input pad pattern 454, an input line pattern 456, a capacitor 458, etc. For example, the flexible printed circuit board 450 can be electrically connected to the second pad part 440 using a film on glass process.

As illustrated in FIG. 5, the fourth pad 442a can be electrically connected to the input line 432b. When the flexible printed circuit board 450 contacts the second pad part 440, the fourth pad 442a can receive signals from the flexible printed circuit board 450.

A typical display device generates driving signals using a driving integrated chip. In this case, the driving signals are stabilized by a capacitor mounted on a flexible printed circuit board, and then the stabilized driving signals are applied to a display region of a display panel through pads and lines formed on the flexible printed circuit board. However, the area of a pad part of the display device that contacts the flexible printed circuit board can be increased. The display device 400 in accordance with example embodiments can generate driving signals (e.g., direct current voltage) using the driving chip 420. Here, the driving signals can be stabilized by the capacitor mounted on at least one of the flexible printed circuit board 450, the driving integrated circuit chip 420, and the display panel 410, and then the stabilized driving signals can be provided to the display region I through the internal lines of the driving integrated circuit chip 420 and the output pads of the driving integrated circuit chip 420. Thus, the lines and the pads can be efficiently arranged in the peripheral region 11. In other words, the lines adjacent to one another and the pads adjacent to one another can be spaced apart from one another by a substantially constant length.

Therefore, a contact defect between the adjacent lines and a contact defect between the adjacent pads can be reduced. As a result, the display device 400 can ensure a relatively improved driving stability (i.e., the display device 400 can be stably driven.)

Example embodiments of the described technology can be employed in any electronic device including a display device. For example, an organic light-emitting diode (OLED) display according to embodiments can be used in a notebook computer, a laptop computer, a digital camera, a video camcorder, a cellular phone, a smart phone, a smart pad, a portable multimedia player (PMP), a personal digital assistant (PDA), a MP3 player, a navigation system, a television, a computer monitor, a game console, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A driver integrated circuit for a display device, comprising:
a base substrate having two opposing short sides and two opposing long sides;
an input pad formed adjacent to one of the long sides;
a first output pad formed adjacent to a first one of the short sides;
a second output pad formed adjacent to a second one of the short sides;
a first internal line formed over the base substrate and electrically connecting the first output pad to the second output pad; and
a second internal line formed over the base substrate and electrically connecting the input pad to the first internal line.

2. The driver integrated circuit of claim 1, wherein the input pad is configured to receive a direct current (DC) voltage and output the DC voltage to a display region of a display panel through the first and second output pads.

3. The driver integrated circuit of claim 2, wherein the input pad is electrically connected to a capacitor configured to stabilize the DC voltage.

4. The driver integrated circuit of claim 3, wherein the capacitor is formed over a flexible printed circuit board (FPCB).

5. The driver integrated circuit of claim 3, wherein the capacitor is formed over the base substrate.

6. The driver integrated circuit of claim 5, wherein the capacitor is electrically connected to the first or second internal line.

7. The driver integrated circuit of claim 3, wherein the capacitor is formed in the display panel.

8. The driver integrated circuit of claim 7, wherein the input pad is electrically connected to an input line extending to a pad part of the display panel and electrically connected to a flexible printed circuit board, and
wherein the capacitor is electrically connected to the input line.

9. The driver integrated circuit of claim 7, wherein the first output pad is electrically connected to a first output line extending to a display region of the display panel, and the second output pad is electrically connected to a second output line extending to the display region, and
wherein the capacitor is electrically connected to at least one of the first and second output lines.

10. The driver integrated circuit of claim 1, wherein the first output pad is electrically connected to a first output line extending to a display region of a display panel, wherein the second output pad is electrically connected to a second input line extending the display region, and
wherein the first and second output lines are electrically connected to each other through the first internal line.

11. The driver integrated circuit of claim 10, wherein the input pad is electrically connected to an input line extending to a pad part of the display panel and electrically connected to a flexible printed circuit board, and
wherein each of the first and second output lines are electrically connected to the input line respectively through the first and second internal lines.

12. The driver integrated circuit of claim 1, wherein the first and second output pads are configured to i) receive a signal from the flexible printed circuit board via the input pad, and ii) provide the received signal to a display region of a display panel.

13. A display device, comprising:
a display panel including a display region and a peripheral region adjacent to the display region; and
a driver integrated circuit formed in the peripheral region and comprising:
a base substrate having two opposing short sides and two opposing long sides;
an input pad formed adjacent to one of the long sides;
a first output pad formed adjacent to a first one of the short sides;
a second output pad formed adjacent to a second one of the short sides;
a first internal line formed over the base substrate and electrically connecting the first output pad to the second output pad; and
a second internal line formed over the base substrate and electrically connecting the input pad to the first internal line.

14. The display device of claim 13, wherein the input pad is electrically connected to a capacitor configured to stabilize the direct current (DC) voltage output through the first and second output pads.

15. The display device of claim 14, wherein the capacitor is formed over the flexible printed circuit board.

16. The display device of claim 15, wherein the flexible printed circuit board includes:
a base film;
an input pad pattern formed over the base film; and
an input line pattern formed over the base film and electrically connected to the input pad pattern,
wherein the capacitor is electrically connected to the input line pattern.

17. The display device of claim 14, wherein the capacitor is electrically connected to at least one of the first and second internal lines.

18. The display device of claim 14, wherein the driver integrated circuit includes:
a first pad electrically connected to the input pad through an input line;
a second pad electrically connected to the first input pad and a first output line extending to the display region; and
a third pad electrically connected to the second input pad and a second output line extending to the display region,
wherein the capacitor is electrically connected to at least one of the input, first output and second output lines.

19. The display device of claim 13, further comprising first and second output lines extending to the display region and electrically connected to each other through the first internal line,
wherein each of the first and second output lines is electrically connected to an input line through the first and second internal lines.

20. The display device of claim 19, further comprising at least one fourth pad electrically connected to the input line, wherein the first and second output pads are configured to receive a signal received from the flexible printed circuit board, and wherein the first and second output pads are configured to output the signal to the display region through the first and second internal lines.
